(19) United States
(12) Patent Application Publication
(10) Pub. No.: US 2023/0068491 A1
(43) Pub. Date: Mar. 2, 2023

(54) METHOD AND SYSTEM FOR AUTOMATICALLY ACTIVATING A CONNECTED CAR SERVICE

(71) Applicants: HYUNDAI MOTOR COMPANY, Seoul (KR); KIA CORPORATION, Seoul (KR)

(72) Inventor: Jaeyoon Ko, Yongin-si (KR)

(73) Assignees: HYUNDAI MOTOR COMPANY, Seoul (KR); KIA CORPORATION, Seoul (KR)

(21) Appl. No.: 17/583,552

(22) Filed: Jan. 25, 2022

(30) Foreign Application Priority Data
Aug. 31, 2021 (KR) 10-2021-0115682

(51) Int. Cl. G07C 5/00; G07C 5/08

(52) U.S. Cl. CPC G07C 5/008; G07C 5/0841

(57) ABSTRACT

A method and system for automatically activating a connected car service is disclosed. To control a connected car service provided by a vehicle through a controller interlocking with a connected car terminal mounted on the vehicle, a connected car server performing wireless communication with the connected car terminal determines whether a newly added connected car service is provided by the vehicle according to a rate system and transmits a determination result to the connected car terminal, so when a controller is newly mounted on the connected car terminal, it is automatically activated without additional checking by a service manager or an additional subscription by a client for activating the newly added service.

### CROSS-REFERENCE TO RELATED APPLICATION

This application claims priority to and the benefit of Korean Patent Application No. 10-2021-0115682, filed on Aug. 31, 2021, the entire contents of which are incorporated herein by reference.

### BACKGROUND

### (a) Field

The present disclosure relates to a method and system for automatically activating a connected car service.

### (b) Description of Related Art

The statements in this section merely provide background information related to the present disclosure and may not constitute prior art.

Research and development of services or functions of a connected car are continuously increasing, and the services or the functions applicable for respective vehicle types or platforms are becoming diversified. The number of countries to which the connected car service is applied is gradually increasing. When the services or the functions of the connected car are added because of software updates or additional new controllers or terminals, the added services or functions need to be activated. For this purpose, an engineer in charge of developing the terminals of the connected car must provide information on a vehicle type of the connected car and addition of new services or functions for the terminals in advance to a manager in charge of managing the server of the connected car, so the manager must change setting information so as to activate new services or functions applied for respective vehicle types and terminals.

The above information disclosed in this Background section is only for enhancement of understanding of the background of the present disclosure, and therefore it may contain information that does not form the prior art that is already known to a person of ordinary skill in the art.

### SUMMARY

The present disclosure has been made in an effort to automatically activate a newly added service without activating the service by a person in charge for each individual controller or service when a new controller is added after connected cars are mass-produced.

The present disclosure has been made in another effort to prevent a person in charge from directly and individually adding a service or a function and inputting a setting value for activation to thus reduce human errors, and accordingly allow a new service or a function to be automatically operated.

The issues of the present disclosure to be solved are not limited to those that are mentioned above, and other tasks that are not uttered may be clearly understood by a person of ordinary skill in the art.

An embodiment of the present disclosure provides a method for automatically activating a connected car service, including: (A) receiving, by a connected car server, a terminal service list from a connected car terminal when the connected car terminal is mounted on a vehicle; (B) determining, by the connected car server, whether there is a service that is not included in a fee service list from among services included in the terminal service list, and adding the service that is not included to the fee service list; and (C) controlling, by the connected car server, the connected car terminal to provide a service that is available according to a rate system from among services included in the fee service list, wherein the terminal service list relates to a service provided through the connected car terminal, and the fee service list relates to a service that is available according to the rate system.

The method may further include determining, by the connected car server, whether there is a service that is not included in an entire list from among services included in the terminal service list, and adding the service that is not included to the entire list, wherein the entire list distinguishes services that are available to a present vehicle for respective vehicles, connected car terminals mounted on the vehicle, and versions of software installed in the connected car terminal.

The (A) includes: receiving, by the connected car server, a signal indicating that a controller is connected from the connected car terminal; when receiving the signal indicating that the controller is connected, checking, by the connected car server, whether the controller is included in a controller list; and when the controller is not included in the controller list according to a checking result in the checking, adding, by the connected car server, the controller to the controller list, and transmitting, by the connected car server, a signal indicating applying of a new controller to the connected car terminal, and the controller list may relate to a connected car terminal mounted on the vehicle and a controller interlocking with the connected car terminal.

The (A) may include, when the controller is included in the controller list according to the checking result, and the service controlled by the controller is not included in the terminal service list, receiving, by the connected car server, a terminal service list including information of the service controlled by the controller from the connected car terminal.

The (C) may include: generating, by the connected car server, terminal activation setting information on the service that is available according to the rate system from among the service included in the fee service list, and transmitting, by the connected car server, the same to the connected car terminal; and applying the terminal activation setting information to allow the vehicle to provide an activated service.

The method may further include (D) controlling, by the connected car server, a user terminal to provide a service that is available according to the rate system from among the services included in the fee service list.

The (D) may include: generating, by the connected car server, application activation setting information on the service that is available according to the rate system from among the services included in the fee service list, and transmitting, by the connected car server, the same to the user terminal; and applying, by the connected car server, the application activation setting information to allow the vehicle to provide an activated service.

Another embodiment of the present disclosure provides a system for automatically activating a connected car service, including: a controller for controlling an operation of the vehicle to provide the connected car service; a connected car terminal mounted on the vehicle; and a connected car server for receiving information on the connected car service from the connected car terminal, managing a plurality of lists on a connected car service program, determining whether the connected car service is provided by the vehicle according to the rate system, and transmitting the determination result to the connected car terminal.

The connected car server may determine whether the controller is included in a controller list when the controller is connected to the connected car terminal, and the connected car server may add information on the controller to the controller list, and the controller list may relate to a connected car terminal mounted on the vehicle and a controller interlocking with the connected car terminal.

When the service controlled by the controller is not included in a terminal service list, the connected car terminal may add information on the service that is not included in the terminal service list from among the services controlled by the controller to the terminal service list, and may transmit the terminal service list to the connected car server, and the terminal service list may relate to the services provided through the connected car terminal.

The connected car server may determine whether there is a service that is not included in a fee service list from among the services included in the terminal service list, and may add the service that is not included to the fee service list, and the fee service list may relate to the services that are available according to the rate system.

The connected car server may determine whether there is a service that is not included in an entire list from among the services that are included in the terminal service list, and may add the service that is not included to the entire list, and the entire list may distinguish the services that are provided to a present vehicle for respective vehicles, connected car terminals mounted on the vehicle, and versions of software installed in the connected car terminal.

The connected car server may control the connected car terminal to provide services that are available according to the rate system from among the services included in the fee service list.

The connected car server may generate terminal activation setting information on the services that are available according to the rate system from among the services included in the fee service list and may transmit the same to the connected car terminal, and the connected car terminal may apply the terminal activation setting information to allow the vehicle to provide an activated service.

The connected car server may control the user terminal to provide services that are available according to the rate system from among the services included in the fee service list.

The connected car server may generate application activation setting information on the services that are available according to the rate system from among the services included in the fee service list and may transmit the same to a user terminal, and an application installed in the user terminal may apply the application activation setting information to allow the vehicle to provide an activated service.

Another embodiment of the present disclosure, a system for automatically activating a connected car service includes: a connected car terminal mounted on a vehicle; and a connected car server configured to: receive information on the connected car service from the connected car terminal, manage a plurality of lists on a connected car service program, determine whether the connected car service is provided by the vehicle according to a rate system, and transmit the determination result to the connected car terminal.

The connected car terminal may transmit a terminal service list to the connected car server, the connected car server may determine whether there is a service that is not included in a fee service list from among the services that are included in a terminal service list, may add the service that is not included to the fee service list, and may control the connected car terminal to provide services that are available according to a rate system from among the services included in the fee service list, the terminal service list may relate to services provided through a connected car terminal, and the fee service list may relate to services that are available according to the rate system.

The connected car server may determine whether there is a service that is not included in an entire list from among the services included in a terminal service list, and may add the service that is not included to the entire list, and the entire list may distinguish the services provided to a present vehicle for respective vehicles, connected car terminals mounted on the vehicle, and versions of software installed in the connected car terminal.

According to another embodiment of the present disclosure, when a new service or a function is added to the connected car, the new service or the function is automatically activated without an additional process for subscribing or activating a service so that the person in charge does not activate the service, and the newly added service is automatically activated.

Further, the person in charge does not directly and individually add a service or a function or input a setting value for activation, so human errors may be reduced, and the new service or the function may be properly operated.

The effects of the present disclosure are not limited to those that are mentioned above, and other effects that are not uttered should be clearly understood by a person skilled in the art from the following description.

### BRIEF DESCRIPTION OF THE DRAWINGS

In order that the disclosure may be well understood, there are now described various forms thereof, given by way of example, reference being made to the accompanying drawings, in which:

FIG. 1 shows a conceptual diagram of a system for automatically activating a connected car service according to an embodiment;

FIG. 2 shows a conceptual diagram of the system of FIG. 1 to which a user terminal is added;

FIG. 3 shows a conceptual diagram of a system for automatically activating a connected car service provided without interlocking with a controller in another embodiment;

FIG. 4 shows a flowchart of a method for automatically activating a connected car service according to an embodiment;

FIG. 5 shows a detailed flowchart of a process for generating activation setting information shown in FIG. 4; and

FIG. 6 shows a flowchart of a method for automatically activating a connected car provided without interlocking with a controller.

The drawings described herein are for illustration purposes only and are not intended to limit the scope of the present disclosure in any way.

### DETAILED DESCRIPTION

The present disclosure relates to a method and system for developing a connected car service by an automation method, reducing an input resource in management, and improving quality of a connected car service.

Embodiments disclosed in the present specification are described in detail with reference to the accompanying drawings. In the present disclosure, the same or similar components are denoted by the same or similar reference numerals, and an overlapped description thereof is omitted. The terms “module” and “unit” for components used in the following description are used only in order to make the disclosure easier. Therefore, these terms do not have meanings or roles that distinguish them from each other by themselves. Those skilled in the art should understand that such blocks, units and/or modules are physically implemented by electronic (or optical) circuits such as logic circuits, discrete components, processors, hard wired circuits, memory devices and wiring connections. When the blocks, units and or modules are implemented by processors or other similar hardware, the blocks, units and modules may be programmed and controlled through software (for example, codes) in order to perform various functions discussed in this disclosure.

In describing embodiments of the present disclosure, when it is determined that a detailed description of the well-known art associated with the present disclosure may obscure the gist of the present disclosure, it is omitted. The accompanying drawings are provided only in order to allow embodiments disclosed in the present disclosure to be easily understood and are not to be interpreted as limiting the spirit disclosed in the present disclosure, and it is to be understood that the present disclosure includes all modifications, equivalents, and substitutions without departing from the scope and spirit of the present disclosure.

Terms including ordinal numbers such as first, second, and the like are used only to describe various components, and are not interpreted as limiting these components. The terms are only used to differentiate one component from others.

It should be further understood that terms “comprises” or “have” used in the present disclosure specify the presence of stated features, numerals, steps, operations, components, parts, or a combination thereof, but do not preclude the presence or addition of one or more other features, numerals, steps, operations, components, parts, or a combination thereof. When a component, device, element, or the like of the present disclosure is described as having a purpose or performing an operation, function, or the like, the component, device, or element should be considered herein as being “configured to” meet that purpose or to perform that operation or function.

From among configurations according to an embodiment, a program that is realized with a set of instructions that are an actualized control algorithm for controlling other configurations may be installed in the configuration for controlling the other configurations in a specific control condition. A control configuration may process input data and stored data according to the installed program and may generate output data. The control configuration may include a non-volatile memory for storing a program and a memory for storing data.

When an embodiment is described hereinafter, a controller list relates to a connected car terminal mounted on a vehicle and a controller interlocking with the connected car terminal.

A terminal service list relates to a service provided through the connected car terminal. A fee service list relates to a service provided according to a rate system. An entire list distinguishes services provided to a present vehicle by respective vehicles, connected car terminals mounted on the vehicle, and versions of software installed in the connected car terminal. The service may represent a concept including the service and the function.

The connected car is a connection of an information communication method and a vehicle, allowing bidirectional Internet and mobile services according to wireless communication. A vehicle on which a connected car terminal 200 is mounted may be referred to as a connected car. A connected car service may be provided by the connected car to a driver who is inside or outside the vehicle through the wireless communication. Hereinafter, a vehicle relating service provided by the connected car is referred to as a connected car service. The connected car is operated to provide the connected car service, and the controller 100 controls the vehicle by collecting information for operating the connected car.

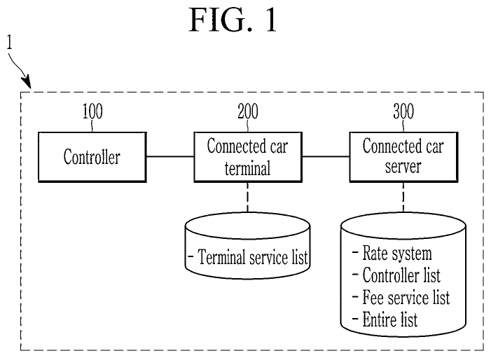

FIG. 1 shows a conceptual diagram of a system for automatically activating a connected car service according to an embodiment.

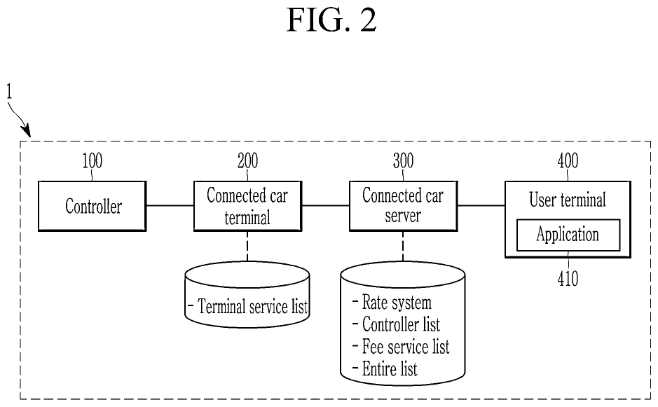

FIG. 2 shows a conceptual diagram of the system of FIG. 1 to which a user terminal is added.

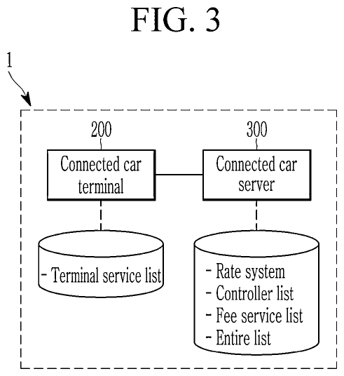

FIG. 3 shows a conceptual diagram of a system for automatically activating a connected car service provided without interlocking with a controller.

The connected car services may be divided into first services (e.g., a remote start service, and a vehicle impact reporting service interlocking with a black box) that may be provided by the connected car terminal 200 interlocking with the controller 100, and second services (e.g., a navigation path guiding service and a server voice recognition service) that may be provided without the interlocking with the controller 100. In other words, the services that may be provided interlocking with the controller are referred to as the first services, and the services that may be provided without the interlocking with the controller are referred to as the second services.

When a vehicle provides the connected car service interlocking with the controller 100, the service controllable by the controller 100 may be referred to as a “service controlled by the controller”.

FIG. 1 and FIG. 2 are used to describe a system for automatically activating a connected car service for allowing a vehicle to provide a first service, and FIG. 3 is used to describe automatically activating a connected car service for allowing a vehicle to provide a second service.

Referring to FIG. 1, the system 1 for automatically activating a connected car service according to an embodiment includes a controller 100, a connected car terminal 200, and a connected car server 300.

The controller 100 controls an operation of a vehicle to provide a connected car service. The controller 100 may control functions provided by the vehicle. The controller 100 may represent a vehicle controller applied when the vehicles are mass-produced or a controller additionally mounted after the vehicles are mass-produced. The controller 100 collects information for operating the connected car and controls the vehicle to provide the connected car service. A vehicle black box controller, a remote start controller, and an SOS call controller may correspond to the controller 100. At least one controller 100 may interlock with one connected car terminal 200.

The connected car terminal 200 is mounted on the vehicle, and transmits information on the connected car service to the connected car server 300 through the wireless communication. The connected car terminal 200 may transmit and receive messages to/from the connected car server 300 through the wireless communication.

The connected car terminal 200 manages a service list relating to functions provided to the connected car. The connected car server 300 manages a plurality of lists on a connected car service program, it determines whether the connected car service may be provided by the vehicle according to a rate system, and it transmits a determination result to the connected car terminal 200. The lists include a controller list, a fee service list, and an entire list.

The connected car server 300 includes a database including the controller list, the fee service list, and the entire list. The database may include a content of the rate system.

Referring to FIG. 2, the system 1 for automatically activating a connected car service without interlocking with the controller includes a connected car terminal 200, a connected car server 300, and a user terminal 400.

An application 410 installed in the user terminal 400 provides information on the service provided to the connected car. The application 410 is installed in the user terminal of the vehicle to receive the connected car service.

Referring to FIG. 3, the system 1 for automatically activating a connected car service according to an embodiment includes a connected car terminal 200 and a connected car server 300.

Referring to FIG. 1 and FIG. 2, when the controller 100 is connected to the connected car terminal 200, the connected car server 300 determines whether the controller 100 is included in the controller list, and adds information of the controller 100 to the controller list when the controller 100 is not included in the controller list. When the service controlled by the controller 100 is not included in the terminal service list, the connected car terminal 200 adds information on the service that is not included in the terminal service list to the terminal service list, and transmits the updated terminal service list to the connected car server 300.

Referring to FIG. 3, when the controller 100 is not connected to the connected car terminal 200, the vehicle may provide the second service through the connected car terminal 200. In this case, the connected car terminal 200 transmits the generated terminal service list to the connected car server 300. In another way, when the software relating to the second service installed in the connected car terminal 200 is changed (e.g., software updates), the connected car terminal 200 applies the modified information to update the terminal service list. The connected car terminal 200 transmits the updated terminal service list to the connected car server 300.

The connected car terminal 200 includes a database including a list of services provided by the connected car terminal 200 as a terminal service list. The connected car terminal 200 transmits the terminal service list to the connected car server 300.

Referring to FIG. 1, FIG. 2, and FIG. 3, the connected car server 300 determines whether there is a service that is not included in the respective fee service list and the entire list of the services included in the terminal service list, and adds the service that is not included in the respective fee service lists to the fee service list and the entire list for an updated fee service list and entire list. The connected car server 300 controls the connected car terminal to provide an available service, among the services included in the fee service list, according to the rate system.

The connected car server 300 receives the terminal service list from the connected car terminal 200, and adds information on the service that is not included in the fee service list from among the services included in the terminal service list to the fee service list. The connected car server 300 receives the terminal service list from the connected car terminal 200, compares the terminal service list with the entire list, and adds information on the service that is not included in the entire list from among the services included in the terminal service list to the entire list. The connected car server 300 transmits terminal activation setting information on the service that is available by the rate system from among the services included in the fee service list to the connected car terminal 200.

The terminal activation setting information represents information on the service activated for the vehicle to provide through the connected car terminal 200, and the connected car terminal 200 may control the vehicle regarding the activated service. Here, the terminal activation setting information may include information for activating a menu on services available to a user according to the rate system and deactivating a menu on other services.

The connected car terminal 200 applies the terminal activation setting information so that the vehicle may provide the activated service. The connected car server 300 controls the user terminal to provide services that are available according to the rate system from among the services included in the fee service list.

The connected car server 300 generates application activation setting information on the services that are available according to the rate system from among the services included in the fee service list and transmits the same (i.e., the generated application activation setting information) to the user terminal 400.

The application activation setting information represents information on the service activated for the vehicle to provide through the connected car terminal 200, and the application 410 installed in the user terminal 400 may control the vehicle to provide the activated service. The application activation setting information may include information for activating a menu on services available to a user according to the rate system and deactivating a menu on other services.

The application 410 installed in the user terminal 400 applies the application activation setting information so that the vehicle may provide the activated service.

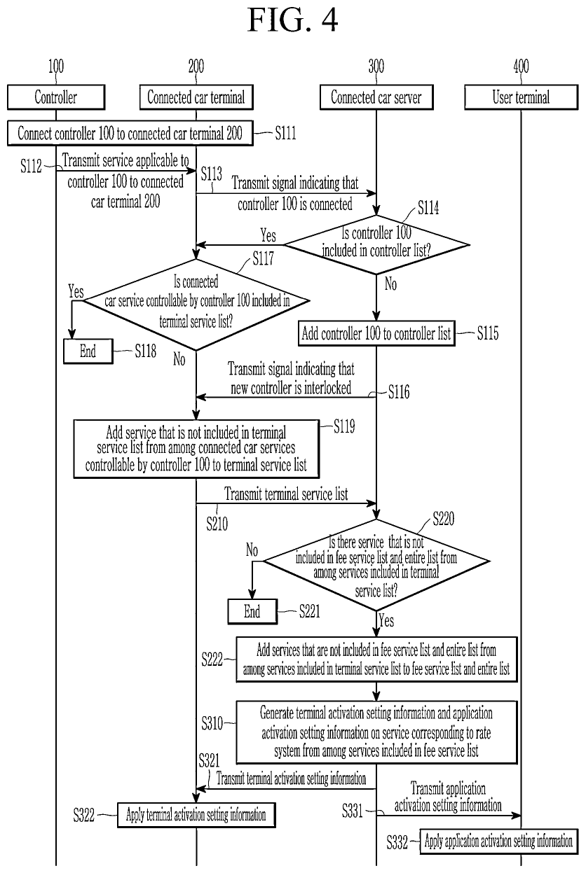

FIG. 4 shows a flowchart of a method for automatically activating a connected car service according to an embodiment. FIG. 4 describes a case in which the connected car provides a first service.

In one embodiment, FIG. 4 shows a flowchart for operations of the controller 100, the connected car terminal 200, the connected car server 300, and the user terminal 400 when the controller 100 is mounted on the connected car terminal 200. An application may be installed in the user terminal 400.

When the connected car terminal 200 is mounted on the vehicle, the connected car server 300 checks the controller 100 interlocking with the connected car terminal 200 from the controller list, and receives a terminal service list from the connected car terminal 200.

The connected car server 300 receives a signal indicating that the controller 100 is connected from the connected car terminal 200.

In detail, the controller 100 is connected to the connected car terminal 200 (S111). The controller 100 transmits information on the service controlled by the controller 100 to the connected car terminal 200 (S112). When receiving the information on the service controlled by the controller 100, the connected car terminal 200 transmits a signal indicating that the controller 100 is connected to the connected car server 300 (S113).

The information on the service controlled by the controller 100 includes information on whether to provide a service program of the connected car service through the connected car terminal 200 and the user terminal 400 according to the rate system. For example, the connected car service may be a black box service, a remote start service, and an SOS call service. Regarding the example, the information indicating that the SOS call service is available and the remote start and the black box service are unavailable in the rate system A, and the SOS call service and the remote start service are available in the rate system B, may correspond to this.

When receiving the signal indicating that the controller 100 is connected, the connected car server 300 checks whether the controller 100 is included in the controller list (S114).

When it is found that the controller is not included in the controller list according to a checking result in S114, the connected car server 300 adds a controller to the controller list, and transmits a signal indicating that a new controller is applied to the connected car terminal 200.

In detail, when not included according to the checking result of S114, the connected car server 300 adds the controller 100 to the controller list (S115). The connected car server 300 transmits a signal indicating that the new controller is interlocked to the connected car terminal 200 (S116).

In other words, when the new controller 100 that has never been interlocked is interlocked to the connected car terminal 200, the connected car server 300 adds the newly interlocked controller 100 to the controller list.

When receiving a signal indicating that the new controller is interlocked from the connected car server 300, the connected car terminal 200 adds the services that are not included in the terminal service list from among the information of the services controlled by the controller 100 to the terminal service list (S119). That is, when all or some of the information of the services controlled by the controller 100 is not included in the terminal service list, the connected car terminal 200 adds information of the services that are not included to the terminal service list. The connected car terminal 200 transmits the terminal service list to the connected car server 300 (S210).

When the controller 100 is included in the controller list and the service controlled by the controller 100 is not included in the terminal service list according to a determination result, the connected car server 300 receives a terminal service list including information on the services controlled by the controller 100 from the connected car terminal 200.

In detail, when included according to the checking result in S114, the connected car terminal 200 determines whether information of the services controlled by the controller 100 is included in the terminal service list (S117). When included according to the determination result, the process ends (S118). That is, the process ends when the information of the services controlled by the controller 100 is already included in the terminal service list.

When not included according to the determination result, and when the connected car terminal 200 receives a signal indicating that the new controller is interlocked from the connected car server 300, the connected car terminal 200 adds services that are not included in the terminal service list from among the information of the services controlled by the controller 100 to the terminal service list (S119). That is, when all or some of the information of the services controlled by the controller 100 is not included in the terminal service list, the connected car terminal 200 adds information of the services that are not included to the terminal service list.

The connected car terminal 200 transmits the terminal service list to the connected car server 300 (S210).

Referring to FIG. 4, the connected car server 300 determines whether there is a service that is not included in the respective fee service list and the entire list from among the services included in the terminal service list, and adds the service that is not included in the respective lists to the fee service list and the entire list.

The connected car server 300 determines whether there is a service that is not included in the fee service list and the entire list from among the services included in the terminal service list received from the connected car terminal 200 (S220). When there is no service that is not included according to the determination result, the process ends (S221). When there is a service that is not included according to the determination result, the connected car server 300 adds the services that are not included in the fee service list and the entire list from among the services that are included in the terminal service list to the fee service list and the entire list (S222). That is, the connected car server 300 updates information of the services included in the fee service list and the entire list with reference to the terminal service list.

Referring to FIG. 4, the connected car server 300 may control the connected car terminal 200 to provide the services that are available according to the rate system from among the services included in the fee service list.

The connected car server 300 generates terminal activation setting information and application activation setting information on the service that corresponds to the rate system from among the services included in the fee service list (S310).

The rate system represents a rate system subscribed by the user between a communication company and/or a manufacturer of the connected car in connection with use of the connected car on which the connected car terminal 200 is mounted. The connected car server 300 may generate setting information so that a specific service of the connected car may be available, available with limits, or unavailable to the user depending on the rate system.

The connected car server 300 transmits terminal activation setting information to the connected car terminal 200 (S321). The terminal activation setting information may signify information for setting availability, availability with limits, and unavailability on the service program provided by the connected car terminal 200 according to the rate system. For example, regarding the rate system A, the SOS call service may include availability, and the remote start and the black box service may include information for setting unavailability. When receiving the terminal activation setting information, the connected car terminal 200 applies terminal activation setting information (S322).

The connected car server 300 may generate terminal activation setting information on the service that is available according to the rate system from among the services included in the fee service list and may transmit the same to the connected car terminal 200, and the connected car terminal 200 may apply the terminal activation setting information to allow the vehicle to provide the activated service.

The connected car server 300 may control the user terminal 400 to provide the service that is available according to the rate system from among the services included in the fee service list.

The connected car server 300 transmits application activation setting information to the user terminal 400 (S331). The application activation setting information may signify information for setting availability, availability with limits, and unavailability on the service program provided by the application 410 installed in the user terminal 400 according to the rate system. For example, regarding the rate system A, the SOS call service may include availability, and the remote start and the black box service may include information for setting unavailability. When receiving the application 410 installed in the user terminal 400 has received the application activation setting information, it applies the application activation setting information (S332).

The connected car server 300 may generate application activation setting information for a service that is available according to the rate system from among the services included in the fee service list and transmit the same to the user terminal 400, and the application 410 installed in the user terminal 400 may apply the application activation setting information to allow the vehicle to provide the activated service.

In other words, the application 410 installed in the connected car terminal 200 and/or the user terminal 400 may activate the service program provided by the application 410 according to the rate system, and it may be operated.

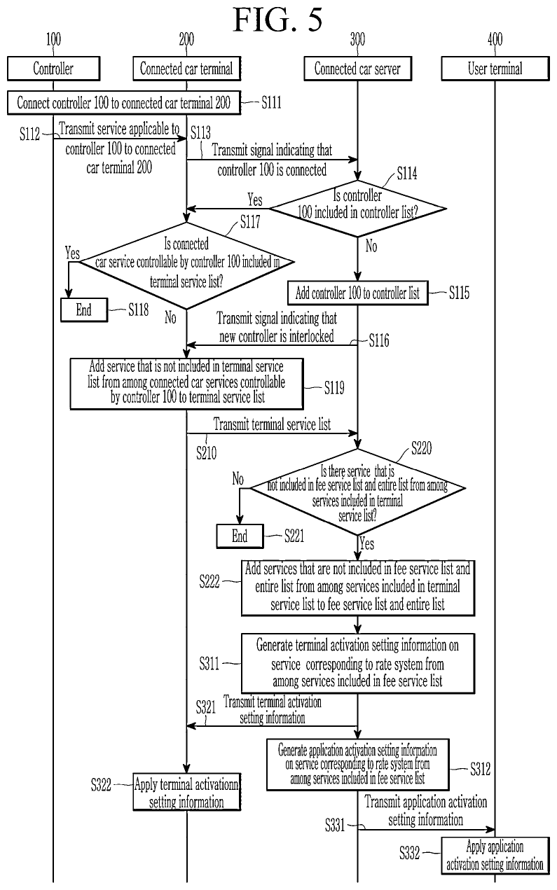

FIG. 5 shows a detailed flowchart of a process for generating activation setting information shown in FIG. 4.

FIG. 5 shows an embodiment of generating terminal activation setting information and application activation setting information and applying the same (S310 to S332) from among the process described with reference to FIG. 4.

Referring to FIG. 5, S111 to S222 may be progressed in a like way of the process described with reference to FIG. 4.

The connected car server 300 generates terminal activation setting information on the service that is available according to the rate system from among the services included in the fee service list and transmits the same to the connected car terminal 200.

In detail, the connected car server 300 adds the services that are not included in the fee service list and the entire list from among the services included in the terminal service list to the respective fee service list and the entire list (S222), and generates terminal activation setting information on the service program that is available according to the rate system through the connected car terminal 200 from among the services included in the fee service list (S311). The connected car server 300 transmits the terminal activation setting information to the connected car terminal 200 (S321).

The terminal activation setting information relates to the service activated for the vehicle to provide through the connected car terminal 200, and the connected car terminal 200 may control the vehicle regarding the activated service. Here, the terminal activation setting information may include information for activating the menu on the service that is available to the user according to the rate system and deactivating the menu on the other services.

The connected car terminal 200 applies the terminal activation setting information to allow the vehicle to provide the activated service (S322).

Referring to FIG. 5, the connected car server 300 controls the user terminal 400 to provide the services that are available according to the rate system from among the services included in the fee service list.

In detail, the connected car server 300 generates application activation setting information on the services that are available according to the rate system from among the services included in the fee service list and transmits the same to the user terminal 400 (S331), and the application 410 installed in the user terminal 400 applies the application activation setting information to allow the vehicle to provide the activated service (S332).

The application activation setting information relates to the service activated for the vehicle to provide through the application 410 installed in the user terminal 400, and the application 410 may control the vehicle regarding the activated service. The application activation setting information may include information for activating the menu on the service that is available to the user according to the rate system and deactivating the menu on the other services.

The process for the connected car server 300 to generate terminal activation setting information and application activation setting information may be progressed concurrently (S310) as described with reference to FIG. 4, or sequentially (S311 and S312) as described with reference to FIG. 5.

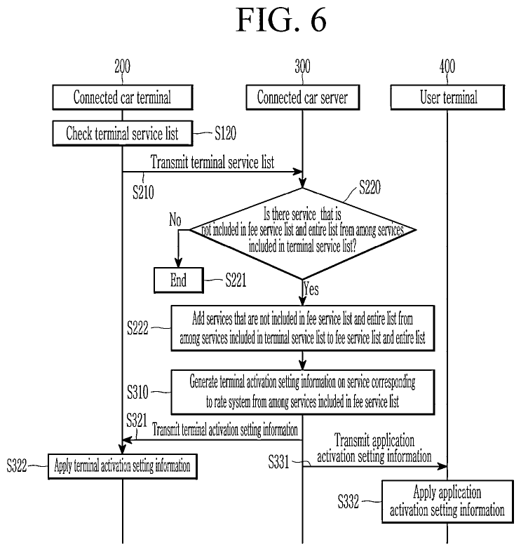

FIG. 6 shows a flowchart of a method for automatically activating a connected car service when a connected car terminal 200 is mounted on a vehicle and a terminal service list according to an embodiment. FIG. 6 is used to describe the case for the connected car to provide a second service.

FIG. 6 shows a flowchart on operations of the connected car terminal 200, the connected car server 300, and the user terminal 400 when a controller (100, not shown) is not mounted on the connected car terminal 200. An application 410 is installed in the user terminal 400.

The connected car server 300 receives a terminal service list from the connected car terminal 200 when the connected car terminal 200 is mounted on the vehicle.

The terminal service list is newly generated when the connected car terminal 200 is mounted on the vehicle and no terminal service list is included in the connected car terminal 200. In another way, the terminal service list may be changed when the connected car terminal 200 is mounted on the vehicle and software applicable to the connected car terminal 200 is changed (e.g., software updates). As described above, the terminal service list presupposes that information of the service included in the terminal service list is modified or deleted when the software applied to the connected car terminal 200 is changed according to, for example, an update, and the connected car service program is modified, added, or deleted.

Referring to FIG. 6, S220 to S332 may be progressed in a like way of the process described with reference to FIG. 4 or FIG. 5.

While this present disclosure has been described in connection with what is presently considered to be practical embodiments, it should be understood that the present disclosure is not limited to the disclosed embodiments, but, on the contrary, is intended to cover various modifications and equivalent arrangements included within the spirit and scope of the disclosure.

### DESCRIPTION OF SYMBOLS

1: system for automatically activating a connected car service

100: controller

200: connected car terminal

300: connected car server

400: user terminal

410: application

What is claimed is:

1. A method for automatically activating a connected car service, the method comprising:
(A) receiving, by a connected car server, a terminal service list from a connected car terminal when the connected car terminal is mounted on a vehicle;
(B) determining, by the connected car server, whether there is a service that is not included in a fee service list from among services included in the terminal service list, and adding the service that is not included to the fee service list; and
(C) controlling, by the connected car server, the connected car terminal to provide a service that is available according to a rate system from among services included in the fee service list,
wherein the terminal service list relates to a service provided through the connected car terminal, and
the fee service list relates to a service that is available according to the rate system.

2. The method of claim 1, further comprising:
determining, by the connected car server, whether there is a service that is not included in an entire list from among services included in the terminal service list, and adding the service that is not included to the entire list,
wherein the entire list distinguishes services that are available to a present vehicle for respective vehicles, connected car terminals mounted on the vehicle, and versions of software installed in the connected car terminal.

3. The method of claim 1, wherein:
the step of (A) comprises:
receiving, by the connected car server from the connected car terminal, a signal indicating that a controller is connected;
when receiving the signal indicating that the controller is connected, checking, by the connected car server, whether the controller is included in a controller list; and
when the controller is not included in the controller list according to a checking result, adding, by the connected car server, the controller to the controller list, and transmitting, by the connected car server, a signal indicating that a new controller is added to the connected car terminal, and
the controller list includes a connected car terminal mounted on the vehicle and a controller interlocking with the connected car terminal.

4. The method of claim 3, wherein:
the step of (A) comprises,
when the controller is included in the controller list according to the checking result, and the service controlled by the controller is not included in the terminal service list, receiving, by the connected car server, a terminal service list including information of the service controlled by the controller from the connected car terminal.

5. The method of claim 1, wherein:
the step of (C) comprises:
generating, by the connected car server, terminal activation setting information on the service that is available according to the rate system from among the service included in the fee service list, and transmitting, by the connected car server, the generated terminal activation setting information to the connected car terminal; and
applying, by the connected car server, the generated terminal activation setting information to allow the vehicle to provide an activated service.

6. The method of claim 1, further comprising:
(D) controlling, by the connected car server, a user terminal to provide a service that is available according to the rate system from among the services included in the fee service list.

7. The method of claim 6, wherein
the step of (D) comprises:
generating, by the connected car server, application activation setting information on the service that is available according to the rate system from among the services included in the fee service list, and transmitting, by the connected car server, the generated application activation setting information to the user terminal; and
applying, by the connected car server, the generated application activation setting information to allow the vehicle to provide an activated service.

8. A system for automatically activating a connected car service, the system comprising:
a controller configured to control an operation of a vehicle to provide the connected car service;
a connected car terminal mounted on the vehicle; and
a connected car server configured to receive information on the connected car service from the connected car terminal, manage a plurality of lists on a connected car service program, determine whether the connected car service is provided by the vehicle according to a rate system, and transmit the determination result to the connected car terminal.

9. The system of claim 8, wherein:
the connected car server is configured to determine whether the controller is included in a controller list when the controller is connected to the connected car terminal, and the connected car server is configured to add information on the controller to the controller list, and
the controller list relates to the connected car terminal mounted on the vehicle and a controller interlocking with the connected car terminal.

10. The system of claim 8, wherein
when the service controlled by the controller is not included in a terminal service list, the connected car terminal adds information on the service that is not included in the terminal service list from among the services controlled by the controller to the terminal service list, and transmits the terminal service list to the connected car server, and
the terminal service list relates to the services provided through the connected car terminal.

11. The system of claim 8, wherein:
the connected car server is configured to determine, among the services included in a terminal service list, whether there is a service that is not included in a fee service list, and add the service that is not included to the fee service list, and
the fee service list relates to the services that are available according to the rate system.

12. The system of claim 8, wherein:
the connected car server is configured to determine whether there is a service that is not included in an entire list of the services that are included in a terminal service list, and add the service that is not included to the entire list, and
the entire list distinguishes the services that are provided to a present vehicle for respective vehicles, connected car terminals mounted on the vehicle, and versions of software installed in the connected car terminal.

13. The system of claim 11, wherein:
the connected car server is configured to control the connected car terminal to provide services that are available according to the rate system from among the services included in the fee service list.

14. The system of claim 13, wherein:
the connected car server is configured to generate terminal activation setting information on the services that are available according to the rate system from among the services included in the fee service list and transmit the generated terminal activation setting information to the connected car terminal, and
the connected car terminal applies the generated terminal activation setting information to allow the vehicle to provide an activated service.

15. The system of claim 11, wherein:
the connected car server is configured to control a user terminal to provide services that are available according to the rate system from among the services included in the fee service list.

16. The system of claim 15, wherein:
the connected car server is configured to generate application activation setting information on the services that are available according to the rate system from among the services included in the fee service list and transmit the generated application activation setting information to the user terminal, and
an application installed in the user terminal applies the generated application activation setting information to allow the vehicle to provide an activated service.

17. A system for automatically activating a connected car service, the system comprising:
a connected car terminal mounted on a vehicle; and
a connected car server configured to: receive information on the connected car service from the connected car terminal, manage a plurality of lists on a connected car service program, determine whether the connected car service is provided by the vehicle according to a rate system, and transmit the determination result to the connected car terminal.

18. The system of claim 17, wherein:
the connected car terminal transmits a terminal service list to the connected car server,
the connected car server is configured to determine, among services that are included in a terminal service list, whether there is a service that is not included in a fee service list, add the service that is not included to the fee service list, and control the connected car terminal to provide services that are available according to the rate system from among services included in the fee service list,
the terminal service list relates to services provided through the connected car terminal, and
the fee service list relates to services that are available according to the rate system.

19. The system of claim 18, wherein:
the connected car server is configured to determine whether there is a service that is not included in an entire list of the services included in the terminal service list, and add the service that is not included to the entire list, and
the entire list distinguishes the services provided to a present vehicle for respective vehicles, connected car terminals mounted on the vehicle, and versions of software installed in the connected car terminal.
